(19) United States
(12) Patent Application Publication
(10) Pub. No.: US 2024/0225351 A1
(43) Pub. Date: Jul. 11, 2024

(54) LIQUID TEMPERATURE HEATING DEVICE

(71) Applicant: Jennifer Hilder, Houston, TX (US)

(72) Inventor: Jennifer Hilder, Houston, TX (US)

(21) Appl. No.: 18/095,794

(22) Filed: Jan. 11, 2023

(51) Int. Cl. A47J 36/24; H05B 3/80

(52) U.S. Cl. CPC A47J 36/2483; H05B 3/80; H05B 2203/021

(57) ABSTRACT

A liquid temperature heating device for heating a liquid within a drinking cup includes a tube being elongated and including a top wall having a perimeter edge. A perimeter wall is coupled to the perimeter edge and protrudes downwardly from the top wall. An end of the perimeter wall is closed and has a hemispherical shape. A bottom section of the tube comprises a thermally conductive material. A heating element is positioned within the tube and emits heat from the tube when activated. A power source is electrically coupled to the heating element and is positioned within the tube. A control circuit is electrically coupled to the heating element and to the power source. A switch is electrically coupled to the control circuit and is engaged by a user to activate the heating element. A container encloses a receiving space to removably store the tube.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to heating devices and more particularly pertains to a new heating device for heating a liquid within a drinking cup.

### (2) Description of Related Art Including Information Disclosed Under 37 CFR 1.97 and 1.98

The prior art relates to heating devices and includes a variety of heating devices configured for heating a liquid. Known prior art does not include a heating device comprising a tube being insertable into a drinking cup to heat a liquid and be removably stored in a case thereafter.

### BRIEF SUMMARY OF THE INVENTION

An embodiment of the disclosure meets the needs presented above by generally comprising a tube being elongated and including a top wall having a perimeter edge. A perimeter wall is coupled to the perimeter edge and protrudes downwardly from the top wall. An end of the perimeter wall is closed and has a hemispherical shape. A bottom section of the tube comprises a thermally conductive material. A heating element is positioned within the tube and emits heat from the tube when actuated. A power source is electrically coupled to the heating element and is positioned within the tube. A control circuit is electrically coupled to the heating element and to the power source. A switch is electrically coupled to the control circuit and is engaged by a user to actuate the heating element. A container encloses a receiving space to removably store the tube when not in-use.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a liquid temperature heating device according to an embodiment of the disclosure.

FIG. 2 is a top perspective view of an embodiment of the disclosure.

FIG. 3 is a side view of an embodiment of the disclosure.

FIG. 4 is a cross-sectional view of an embodiment of the disclosure taken along Line 4-4 of FIG. 1.

FIG. 5 is an in-use view of an embodiment of the disclosure.

FIG. 6 is a front view of an alternative embodiment of the disclosure.

FIG. 7 is a top perspective view of an embodiment of the disclosure.

FIG. 8 is a top perspective view of an embodiment of the disclosure.

### DETAILED DESCRIPTION OF THE INVENTION

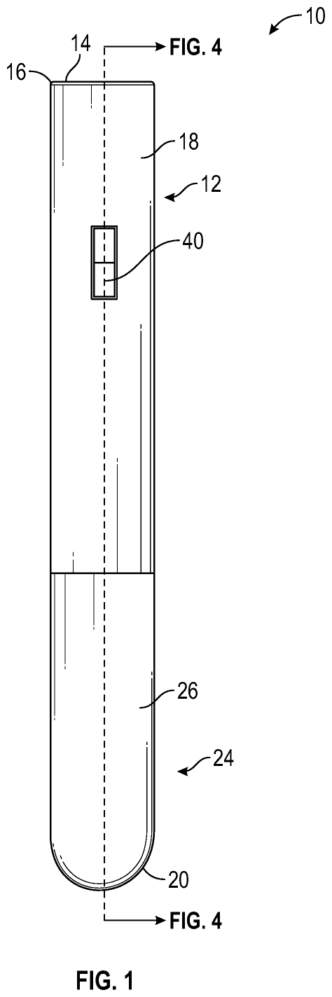

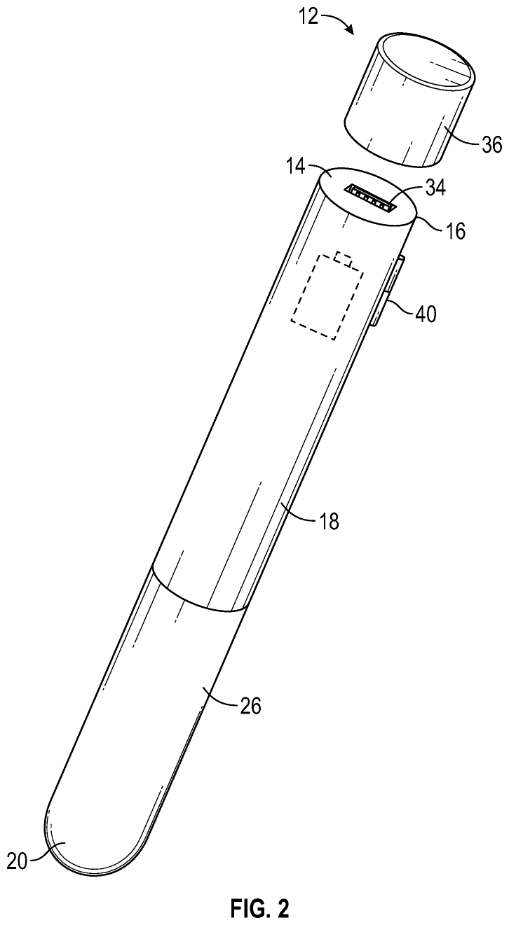

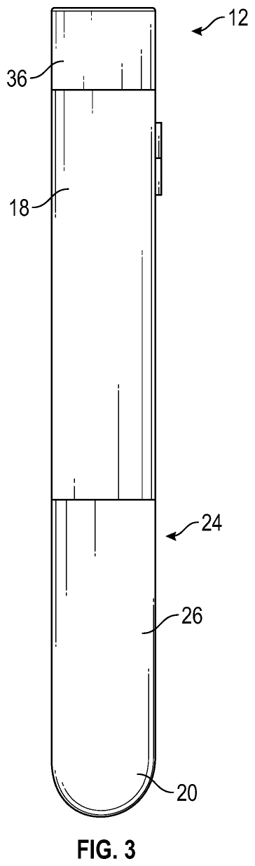

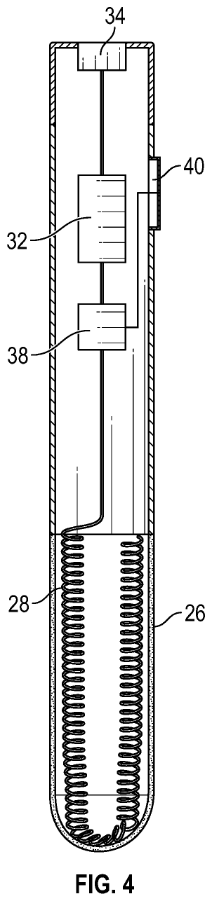

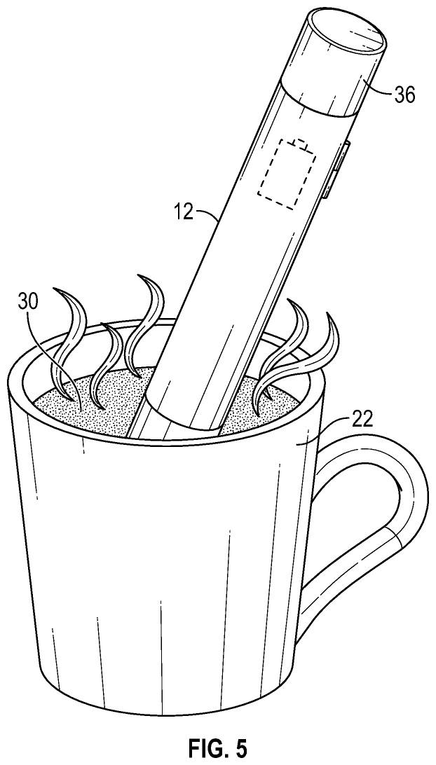

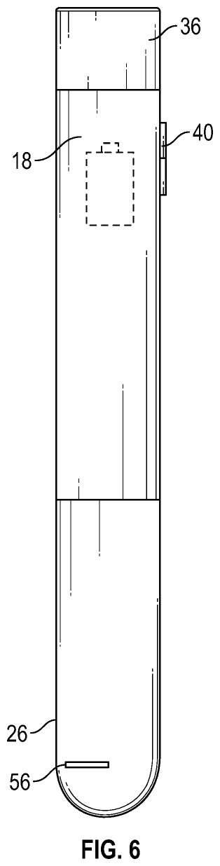

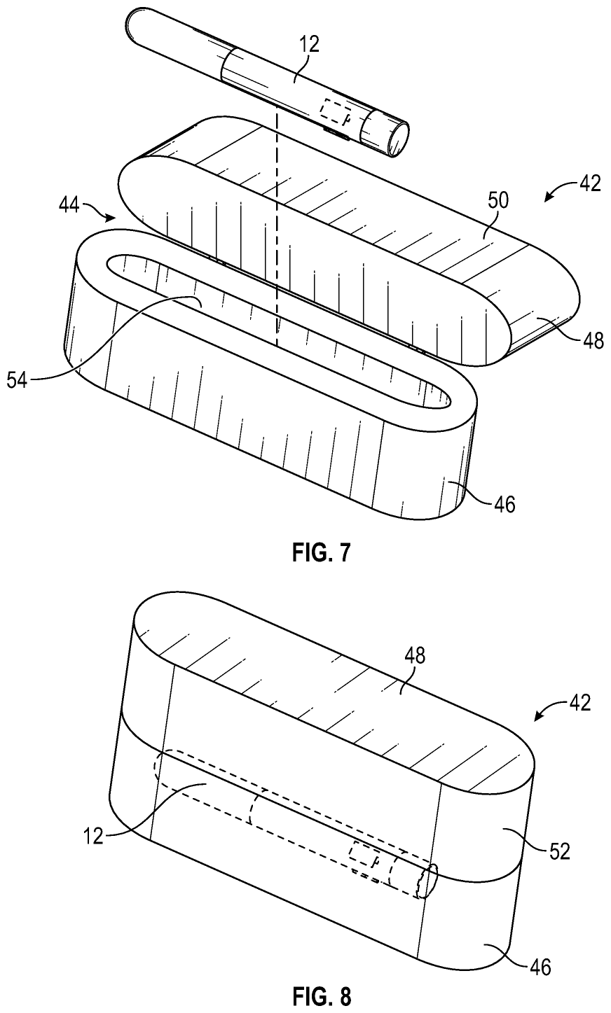

With reference now to the drawings, and in particular to FIGS. 1 through 8 thereof, a new heating device embodying the principles and concepts of an embodiment of the disclosure and generally designated by the reference numeral 10 will be described.

As best illustrated in FIGS. 1 through 7, the liquid temperature heating device 10 generally comprises As best illustrated in FIGS. 1 through 6, the nameinvent 10 generally comprises a tube 12 being elongated and includes a top wall 14 having a perimeter edge 16. A perimeter wall 18 is coupled to the perimeter edge 16 and protrudes downwardly from the top wall 14. An end 20 of the perimeter wall 18 is closed and typically has a hemispherical shape being abuttable to a bottom of an interior of a drinking cup 22. A bottom section 24 of the tube 12 comprises a thermally conductive material 26 such as metal or any other conventional conductive material.

A heating element 28 is positioned within the tube 12 and emits heat from the tube 12 when actuated. The heating element 28 is positioned adjacent to the thermally conductive material 26 of the bottom section 24 to facilitate heat transfer from the tube 12 to a liquid 30 such as coffee or tea. The heating element 28 normally comprises a plurality of electric heating coils.

A power source 32 is electrically coupled to the heating element 28 and is positioned within the tube 12. The power source 32 comprises a battery and may be rechargeable. A charging port 34 may be positioned on the top wall 14 and may be electrically coupled to the power source 32. The charging port 34 typically comprises a universal serial bus port. A lid 36 is removably positioned on the top wall 32 of the tube 12 to enclose the charging port 34 within a space to prevent liquid from damaging the charging port 34.

A control circuit 38 is electrically coupled to the heating element 28 and to the power source 32. The control circuit 38 is normally positioned within the tube 12. A switch 40 is electrically coupled to the control circuit 38 and is engaged by a user to actuate the heating element 28. The switch 40 is normally coupled to the perimeter wall 18. The switch 40 may comprise a button, a dial, or any other conventional switch.

A container 42 encloses a receiving space 44 to removably store the tube 12 when not in-use. The container 42 typically includes a base section 46 and a top section 48 is pivotally coupled to the base section 46, wherein the top section 48 is pivotally positionable from an open position 50 to a closed position 52. The open position 50 exposes the receiving space 44 and the closed position 52 conceals the receiving space 44. The receiving space 44 may have a cavity 54 comprising a similar shape to the tube 12, wherein the cavity 54 removably receives the tube 12.

A temperature sensor 56 may be electrically coupled to the control circuit 38 and may be mounted on the end of the perimeter wall 18. The temperature sensor 56 may be configured to measure a temperature of the liquid 30 abutting the bottom section 24 of the tube 12 and powering off the heating element 28 when the liquid 30 measures a temperature programmed by the control circuit to be optimal for a heated beverage. The temperature may be from 140 Fahrenheit to 160 Fahrenheit.

In use, the bottom section 24 of the tube 12 is inserted within the drinking cup 22 containing the liquid 30 such as a coffee mug containing coffee. The switch 40 is engaged by the user to actuate the heating element 28, wherein the tube 12 begins to heat the liquid 30. The switch 40 may be engaged by the user again to power off the heating element 28 after the liquid 30 is heated to the desired temperature. The temperature sensor 56 may power off the heating element 28 after the temperature sensor 56 is triggered by the liquid 30 reaching the temperature programmed by the control circuit 38. The tube 12 may be stored within the container 42 thereafter.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A beverage heating device comprising:
a tube being elongated and including a top wall having a perimeter edge, a perimeter wall being coupled to the perimeter edge and protruding downwardly from the top wall, an end of the perimeter wall being closed and having a hemispherical shape, a bottom section of the tube comprising a thermally conductive material;
a heating element being positioned within the tube, the heating element emitting heat from the tube when actuated;
a power source being electrically coupled to the heating element, the power source being positioned within the tube;
a control circuit being electrically coupled to the heating element and to the power source;
a switch being electrically coupled to the control circuit, the switch being engaged by a user to actuate the heating element; and
a container enclosing a receiving space, the receiving space removably storing the tube when not in-use.

2. The beverage heating device of claim 1, wherein the heating element is positioned adjacent to the thermally conductive material of the bottom section, the heating element comprising a plurality of electric heating coils.

3. The beverage heating device of claim 1, wherein the power source comprises a battery and is rechargeable, a charging port being positioned on the top wall and being electrically coupled to the power source.

4. The beverage heating device of claim 3, further including a lid being removably positioned on the top wall of the tube, the lid enclosing the charging port within a space to prevent liquid from damaging the charging port.

5. The beverage heating device of claim 1, wherein the control circuit is positioned within the tube.

6. The beverage heating device of claim 1, wherein the control circuit is programmable.

7. The beverage heating device of claim 1, wherein the switch is coupled to the perimeter wall.

8. The beverage heating device of claim 1, wherein the container includes a base section and a top section being pivotally coupled to the base section, wherein the top section is pivotally positionable from an open position to a closed position, the receiving space having a cavity to removably receive the tube

9. The beverage heating device of claim 6, further including a temperature sensor being electrically coupled to the control circuit, the temperature sensor being mounted on the end of the perimeter wall, the temperature sensor being configured for measuring a temperature of a liquid abutting the bottom section of the tube and powering off the heating element when the liquid measures a temperature programmed by the control circuit.

10. A beverage heating device comprising:
a tube being elongated and including a top wall having a perimeter edge, a perimeter wall being coupled to the perimeter edge and protruding downwardly from the top wall, an end of the perimeter wall being closed and having a hemispherical shape, a bottom section of the tube comprising a thermally conductive material;
a heating element being positioned within the tube, the heating element emitting heat from the tube when actuated, the heating element being positioned adjacent to the thermally conductive material of the bottom section, the heating element comprising a plurality of electric heating coils;
a power source being electrically coupled to the heating element, the power source being positioned within the tube, the power source comprising a battery and being rechargeable, a charging port being positioned on the top wall and being electrically coupled to the power source;
a lid being removably positioned on the top wall of the tube, the lid enclosing the charging port within a space to prevent liquid from damaging the charging port;
a control circuit being electrically coupled to the heating element and to the power source, the control circuit being positioned within the tube, said control circuit being programmable;
a switch being electrically coupled to the control circuit, the switch being engaged by a user to actuate the heating element, the switch being coupled to the perimeter wall;
a container enclosing a receiving space, the receiving space removably storing the tube when not in-use, the container including a base section and a top section being pivotally coupled to the base section, wherein the top section is pivotally positionable from an open position to a closed position, the receiving space having a cavity to removably receive the tube; and
a temperature sensor being electrically coupled to the control circuit, the temperature sensor being mounted on the end of the perimeter wall, the temperature sensor being configured for measuring a temperature of a liquid abutting the bottom section of the tube and powering off the heating element when the liquid measures a temperature programmed by the control circuit.
